(19) United States
(12) Patent Application Publication
(10) Pub. No.: US 2025/0166138 A1
(43) Pub. Date: May 22, 2025

(54) OBJECT AND ROAD CONTOUR ADJUSTMENT METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Jinyan LIU, Shenzhen (CN)

(73) Assignee: Tencent Technology (Shenzhen) Company Limited, Shenzhen (CN)

(21) Appl. No.: 19/035,602

(22) Filed: Jan. 23, 2025

Related U.S. Application Data
(63) Continuation of application No. PCT/CN2023/128980, filed on Nov. 1, 2023.

(30) Foreign Application Priority Data
Jan. 4, 2023 (CN) 2023100099961

(51) Int. Cl. G06T 5/70; G06T 7/50

(52) U.S. Cl. CPC G06T 5/70; G06T 7/50

(57) ABSTRACT

An object contour adjustment method including: obtaining a target image, the target image including a target object; performing contour recognition on the target object to obtain a reference contour, the reference contour including a plurality of reference key points, which are the key points on corners of the reference contour; determining a gradient change result corresponding to each of the plurality of reference key points, the gradient change result corresponding to the reference key point being configured for indicating an angle between contour edges obtained by connecting adjacent reference key points in the reference contour; determining the reference key point that meets the gradient change condition as a target key point; and determining a target contour corresponding to the target object based on key point connection results among the plurality of target key points, contour edge flatness of the target contour being higher than that of the reference contour.

### RELATED APPLICATION

This application is a continuation of and claims the benefit of priority to PCT Application No. PCT/CN2023/128980, filed Nov. 1, 2023, and entitled OBJECT CONTOUR ADJUSTMENT METHOD AND APPARATUS, ROAD CONTOUR ADJUSTMENT METHOD AND APPARATUS, DEVICE, MEDIUM, AND PROGRAM PRODUCT, which claims priority to application Ser. No. 2023100099961, filed on Jan. 4, 2023, and entitled “OBJECT CONTOUR ADJUSTMENT METHOD AND APPARATUS, DEVICE, STORAGE MEDIUM, AND PROGRAM PRODUCT.” The above applications are incorporated herein by reference in their entireties.

### FIELD OF THE TECHNOLOGY

This application relates to the field of image processing, and in particular, to an object contour adjustment method and apparatus, a device, a storage medium, a program product, a road contour adjustment method and apparatus, a device, a storage medium, and a program product.

### BACKGROUND OF THE DISCLOSURE

With the continuous development of computer technologies, a user needs to rely on an electronic map to learn a current urban road condition in advance during traveling. After a road picture of the road condition is usually captured by a satellite, a road contour is identified, and then a corresponding contour of the road is marked on the road picture, which helps the user become familiar with a shape of the road.

In the related art, in a process of rendering a road to generate a road contour, pixel points where the road is located are usually marked in an entire image, and a contour generated by connecting the pixel points is used as the road contour.

However, in the related art, due to a complex road condition, a generated road shape has excessive burrs, causing a final displayed road contour to be not aesthetic enough and not to meet to an actual road condition, and reducing accuracy of the road contour.

### SUMMARY

Embodiments of this application provide an object contour adjustment method and apparatus, a device, a storage medium, and a program product, which can improve flatness of an object contour edge. Technical solutions are as follows:

According to an aspect, an object contour adjustment method is provided, performed by a computer device, the method including:
obtaining a target image, the target image including a target object;
performing contour recognition on the target object to obtain a reference contour, the reference contour including a plurality of reference key points, the reference key points being key points on corners of the reference contour;
determining a gradient change result corresponding to each of the plurality of reference key points, the gradient change result corresponding to the reference key point being configured for indicating an angle between contour edges obtained by connecting adjacent reference key points in the reference contour;
determining, when a reference key point that meets a gradient change condition exists in the plurality of reference key points, the reference key point that meets the gradient change condition as a target key point; and
determining a target contour corresponding to the target object based on key point connection results among the plurality of target key points, contour edge flatness of the target contour being higher than that of the reference contour.

According to another aspect, a road contour adjustment method is provided, applied to a road contour recognition scene, the method including:
obtaining a road image of a specified scene, the road image being an image generated by photographing the specified scene within a specified perspective range, and the road image including a target road;
performing contour recognition on the target road to obtain a reference contour, the reference contour including a plurality of reference key points, the reference key points being key points on corners of the reference contour;
determining a gradient change result corresponding to each of the plurality of reference key points, the gradient change result corresponding to the reference key point being configured for indicating an angle between contour edges obtained by connecting adjacent reference key points in the reference contour;
determining, when a reference key point that meets a gradient change condition exists in the plurality of reference key points, the reference key point that meets the gradient change condition as a target key point; and
determining a target road contour corresponding to the target road based on key point connection results among the plurality of target key points, contour edge flatness of the target road contour being higher than that of the reference contour.

According to another aspect, an object contour adjustment apparatus is provided, the apparatus including:
a first obtaining module, configured to obtain a target image, the target image including a target object;
a first recognition module, configured to perform contour recognition on the target object to obtain a reference contour, the reference contour including a plurality of reference key points, the reference key points being key points on corners of the reference contour; and
a first determining module, configured to determine a gradient change result corresponding to each of the plurality of reference key points, the gradient change result corresponding to the reference key point being configured for indicating an angle between contour edges obtained by connecting adjacent reference key points in the reference contour.

The first determining module is further configured to determine, when a reference key point that meets a gradient change condition exists in the plurality of reference key points, the reference key point that meets the gradient change condition as a target key point.

The first determining module is further configured to determine a target contour corresponding to the target object based on key point connection results among the plurality of target key points, contour edge flatness of the target contour being higher than that of the reference contour.

According to another aspect, a road contour adjustment apparatus, the apparatus including:
a second obtaining module, configured to obtain a road image of a specified scene, the road image being an image generated by photographing the specified scene within a specified perspective range, and the road image including a target road;
a second recognition module, configured to perform contour recognition on the target road to obtain a reference contour, the reference contour including a plurality of reference key points, the reference key points being key points on corners of the reference contour; and
a second determining module, configured to determine a gradient change result corresponding to each of the plurality of reference key points, the gradient change result corresponding to the reference key point being configured for indicating an angle between contour edges obtained by connecting adjacent reference key points in the reference contour.

The second determining module is further configured to determine, when a reference key point that meets a gradient change condition exists in the plurality of reference key points, the reference key point that meets the gradient change condition as a target key point.

The second determining module is further configured to determine a target road contour corresponding to the target road based on key point connection results among the plurality of target key points, contour edge flatness of the target road contour being higher than that of the reference contour.

According to another aspect, a computer device is provided, including a processor and a memory, the memory having at least one instruction, a computer-readable instruction, a code set, or an instruction set stored therein, the at least one instruction, the computer-readable instruction, the code set, or the instruction set being loaded and executed by the processor to implement the method according to any one of the foregoing embodiments of this application.

According to another aspect, a computer-readable storage medium is provided, the storage medium having a computer-readable instruction stored therein, the computer-readable instruction being loaded and executed by a processor to implement the method according to any one of the foregoing embodiments of this application.

According to another aspect, a computer program product or a computer program is provided, the computer program product or the computer program including a computer-readable instruction, the computer-readable instruction being stored in a computer-readable storage medium. A processor of the computer device reads the computer-readable instruction from the computer-readable storage medium. The processor executes the computer-readable instruction, causing the computer device to perform the method according to any one of the foregoing embodiments.

Details of one or more embodiments of this application are provided in the accompanying drawings and descriptions below. Other features and advantages of this application become significant with reference to the specification, the accompanying drawings, and the claims.

### BRIEF DESCRIPTION OF THE DRAWINGS

To describe the technical solutions in the embodiments of this application or the related art more clearly, the following briefly describes the accompanying drawings required for describing the embodiments or the related art. Apparently, the accompanying drawings in the following descriptions show merely some embodiments of this application, and a person of ordinary skill in the art may still derive other drawings from these accompanying drawings without creative efforts.

FIG. 1 is an example schematic diagram of an implementation environment according to an exemplary embodiment of this application.

FIG. 2 is an example flowchart of an object contour adjustment method according to an exemplary embodiment of this application.

FIG. 3 is an example flowchart of an object contour adjustment method according to an exemplary embodiment of this application.

FIG. 4 is an example comparison diagram of a target contour and a real contour according to another exemplary embodiment of this application.

FIG. 5 is an example flowchart of a road contour adjustment method according to an exemplary embodiment of this application.

FIG. 6 is an example schematic comparison diagram of a target image according to an exemplary embodiment of this application and an image obtained by processing the target image by using a road contour adjustment method provided in an embodiment of this application.

FIG. 7 is an example schematic diagram of an object contour adjustment method according to an exemplary embodiment of this application.

FIG. 8 is an example structure diagram of an object contour adjustment apparatus according to an exemplary embodiment of this application.

FIG. 9 is an example structure diagram of an object contour adjustment apparatus according to another exemplary embodiment of this application.

FIG. 10 is an example structure diagram of a road contour adjustment apparatus according to an exemplary embodiment of this application.

FIG. 11 is an example schematic structural diagram of a server according to an exemplary embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

Polygon regularization: An original polygon is sampled to obtain a smoother polygon than the original polygon, while retaining an original shape to a certain extent. In other words, a sampled polygon is similar to the original polygon.

In view of the introduction of the foregoing term, an implementation environment involved in this embodiment of this application is described. The implementation environment includes a terminal. A target application is installed in the terminal. The target application may be implemented as a stand-alone application or an online application.

For example, refer to FIG. 1. The implementation environment involves a terminal 110 and a server 120. The terminal 110 is connected to the server 120 through a communication network 130. An application 111 that supports an image rendering function is installed in the terminal 110, such as at least one of different types of applications such as a navigation application, a map application, a video playback application, and a drawing application.

First, a description is provided by using an example in which the application 111 is the stand-alone application. The terminal 110 inputs a target image. The target image includes a target object, and a contour recognition is performed on the target object to obtain a corresponding reference contour of the target object. The reference contour includes a plurality of reference key points. Gradient change results corresponding to the plurality of reference key points are determined. If a reference key point that meets a gradient change condition exists, the reference key point is used as a target key point. Finally, a target contour corresponding to the target object is determined based on a key point connection result among the plurality of target key points, so that an edge flatness of the target contour is higher than that of the reference contour.

Next, a description is provided by using an example in which the application 111 is the online application. The terminal 110 obtains a target image including the target object, generates a contour recognition request, and transmit the contour recognition request to the server 120. The contour recognition request includes the target image.

After receiving the contour recognition request, the server 120 performs contour recognition on the target object in the target image in the contour recognition request, to obtain a reference contour corresponding to the target object. The reference contour includes a plurality of reference key points. The server 120 determines an angle among contour edges obtained by connecting each reference key point with adjacent reference key points as a gradient change result corresponding to the reference key point. When a reference key point that meets the gradient change condition exists, the reference key point is determined as the target key point. Finally, the target contour corresponding to the target object is determined based on the key point connection result among the plurality of target key points. An image labeled with the target contour corresponding to the target object is outputted and fed back to the terminal 110 as the contour recognition result. After receiving the contour recognition result, the terminal 110 displays the image labeled with the target contour.

The terminal 110 includes at least one of terminals such as a smart phone, a tablet computer, a portable laptop computer, a desktop computer, a smart speaker, a smart wearable device, a smart voice interactive device, a smart household appliance, and an on-board terminal.

The foregoing server 120 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The cloud technology refers to a hosting technology that unifies series of resources such as hardware, software, and network in a wide area network or a local area network, to implement computing, storage, processing, and sharing of data.

In some embodiments, the foregoing server 120 may further be implemented as a node in a blockchain system.

Information (including but not limited to user device information and user personal information), data (including but not limited to data for analysis, stored data, and displayed data), and signals involved in this application are all authorized by users or fully authorized by all parties, and collection, use, and processing of relevant data need to comply with relevant laws, regulations, and standards of relevant countries and regions. For example, a network connection request involved in this application is obtained under full authorization.

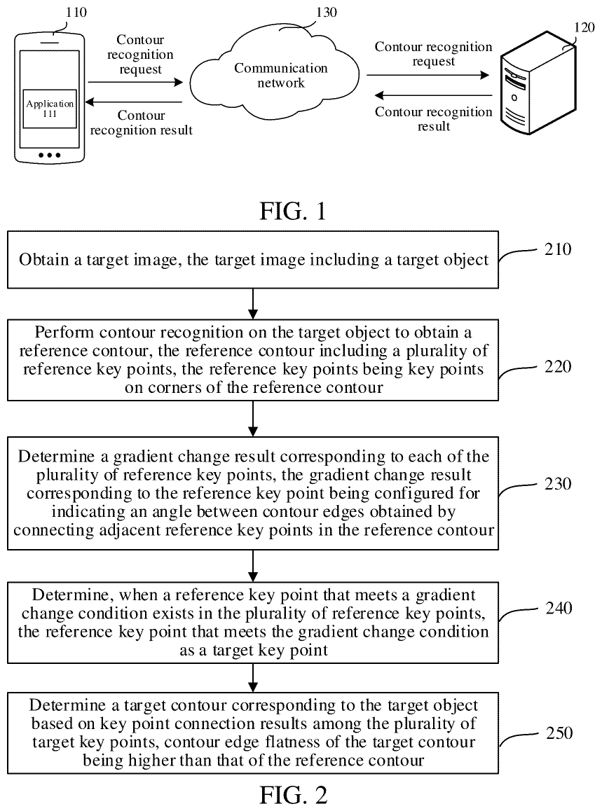

For example, an object contour adjustment method provided in this application is described. FIG. 2 is a flowchart of an object contour adjustment method according to an exemplary embodiment of this application. As shown in FIG. 2, the method includes the following operations.

Operation 210: Obtain a target image, the target image including a target object.

The target image refers to a specific image, which needs to meet a specific condition. In other words, the target object is included. The target object is a specific object, and is not an arbitrary object. The target object may be specified based on a service requirement. For example, the target object may be a road, a person, or an animal.

For example, the target image is an image that includes at least one target object. The target object may be a closed shape figure, such as a rectangle. Alternatively, the target object is an open figure, which is not limited.

In some embodiments, the target image is obtained from at least one of the following: 1. an image generated by a specified photographing device within a specified photographing range, the specified photographing range including the target object; 2. an image designed by a user, the image including a target object designed by the user; and 3. an image downloaded from an authorized public website. The foregoing manner of obtaining the target image is merely a schematic example, which is not limited in this embodiment of this application.

In some embodiments, the target image is a color image. In other words, the target image includes an object corresponding to the target object. Alternatively, the target image is a pixel point distribution image. In other words, the target image includes a pixel point distribution result corresponding to the target object. Alternatively, the target image is an assigned image. In other words, in the target image, a pixel point region in which the target object is located is labeled as 1, and the remaining pixel points are labeled as 0.

In some embodiments, the target image includes a complete target object. Alternatively, the target image includes part of the target object, which is not limited.

In some embodiments, the target image is labeled with the target object when being obtained. For example, a region in which the target object is located in the target image is labeled. Alternatively, the target object is not labeled when the target image is obtained. After object recognition is performed on the target image, the target object included in the target image is determined, which is not limited.

Operation 220: Perform contour recognition on the target object to obtain a reference contour, the reference contour including a plurality of reference key points, the reference key points being key points on corners of the reference contour.

The reference contour includes a plurality of reference key points, and the reference key points are key points on corners of the reference contour. The key points are some specific isolated points that may express a changing trend of a contour.

In some embodiments, the contour recognition is configured for identifying and obtaining the reference contour corresponding to the target object in the target image.

In some embodiments, the reference contour is an irregular-shaped contour. The irregular-shaped contour is a contour with an irregular shape. The irregular shape may be a shape that cannot be directly described mathematically by using limited parameters. Direct description means being able to accurately describe, rather than fit or approximate.

For example, the target object refers to an object whose contour formed by an edge to which the object belongs in the target image is the irregular-shaped contour. The irregular-shaped contour includes at least one case in which the contour edge corresponding to the target object is an uneven curved edge and the contour shape corresponding to the target object is an irregular mathematical shape. A regular mathematical shape is a shape that can be directly described mathematically by using limited parameters, including a rectangle, a square, a trapezoid, a triangle, a polygon, and a circle.

For example, the reference contour refers to a contour generated from an actual contour of the target object with corners thereof retained. The corners refer to corresponding vertices which determine a shape of the reference contour of the target object. In other words, the reference contour corresponding to the target object and the actual contour of the target object have overlapping edges and non-overlapping edges.

In some embodiments, the reference contour can be composed of open connection lines or closed connection lines. Alternatively, the reference contour may be composed of a plurality of key points, which is not limited.

In some embodiments, a method for recognizing the reference contour includes at least one of the following recognition methods. 1. First, a reference point set corresponding to the target object is obtained, a distance of adjacent reference key points in the reference point set is calculated, and the reference contour is determined based on calculated adjacent key points. 2. The target image is inputted into a pre-trained contour recognition model, and a corresponding contour recognition result of the target object is outputted. The contour recognition result is implemented by marking the pixel point at the edge of the target object. 3. A channel value of each pixel point in the target image is analyzed, a color channel value corresponding to each pixel point in the target image is obtained, and the color channel value corresponding to the target object is determined. Based on the region where the target object is located, the pixel point with a sudden change in the pixel point channel value is the pixel point where the corresponding contour of the target object is located. 4. The target image is labeled with the target object. After the edge of the target object is drawn, the reference contour corresponding to the target object is obtained.

The foregoing method for recognizing the reference contour is merely a schematic example, which is not limited in this embodiment of this application.

In some embodiments, the reference key point is a point on an edge of the target object. Alternatively, the reference key point is a point at the edge of the target object, which is not limited.

In some embodiments, the reference key points are arranged in the same manner as the real contour of the target object. Alternatively, the reference key points are arranged in a manner similar to the real contour of the target object, which is not limited.

Operation 230: Determine a gradient change result corresponding to each of the plurality of reference key points, the gradient change result corresponding to the reference key point being configured for indicating an angle between contour edges obtained by connecting adjacent reference key points in the reference contour.

The computer device may traverse each of the plurality of reference key points. The gradient change result corresponding to each reference key point is determined, and then the gradient change results corresponding to the plurality of reference key points are obtained at an end of the traversal.

The gradient change results corresponding to the reference key points are configured for indicating an angle between the contour edges obtained by connecting adjacent reference key points in the reference contour.

In some embodiments, the reference contour of the target object is a contour formed by connecting the plurality of reference key points. A contour edge is obtained by connecting two adjacent reference key points. For example, the plurality of reference key points include a reference key point a, a reference key point b, and a reference key point c which are adjacent to each other. The reference key point a is connected to the reference key point b to obtain a contour edge d. The reference key point b is connected to the reference key point c to obtain a contour edge e. Since both the contour edge d and the contour edge e include the reference key point b, the contour edge d and the contour edge e are used as the two contour edges corresponding to the reference key point b. A gradient change result corresponding to the reference key point b is a slope change result between a slope corresponding to the contour edge d and a slope corresponding to the contour edge e, to be specific, an angle between the contour edge d and the contour edge e.

In some embodiments, the angle between the contour edge d and the contour edge e is an angle toward an interior of the target object. Alternatively, the angle between the contour edge d and the contour edge e is an angle toward an exterior of the target object. Alternatively, when the angle toward the interior of the target object is greater than 180 degrees, the angle towards the exterior of the target object is selected. When the angle toward the interior of the target object is less than 180 degrees, the angle toward the interior of the target object is selected, which is not limited.

In some embodiments, the computer device may use a certain reference key point among the plurality of reference key points as a starting point of traversal, and traverse the plurality of reference key points clockwise or counterclockwise along the reference contour of the target object.

In some embodiments, the computer device may use a reference key point at a specified position as the starting point of traversal (for example, use a reference key point at an upper left corner of the target object as the starting point of traversal), and traverse the plurality of reference key points clockwise or counterclockwise along the reference contour of the target object.

For example, during traversal of the plurality of reference key points, after two contour edges corresponding to the reference key points are determined, an angle corresponding to the two contour edges is calculated as the gradient change result corresponding to the reference key points.

In some embodiments, during traversal of the plurality of reference key points, after two contour edges corresponding to a reference key point are determined, the gradient change result corresponding to the reference key point is determined based on the two contour edges corresponding to the reference key points. Alternatively, during traversal of the plurality of reference key points, after the two contour edges corresponding to the plurality of reference key points are determined, the gradient change result corresponding to each reference key point is calculated.

In some embodiments, when the target image includes a plurality of target objects, the plurality of reference key points included in each target object determine corresponding gradient change results in sequence. Alternatively, each target object simultaneously determines the gradient change results corresponding to the plurality of reference key points that are included.

Operation 240: Determine, when a reference key point that meets a gradient change condition exists in the plurality of reference key points, the reference key point that meets the gradient change condition as a target key point.

The target key point is a specific reference key point screened from the plurality of reference key points, and a screened reference key point meets the gradient change condition.

In some embodiments, the gradient change condition includes at least one of the following condition types.
1. An angle threshold is set in advance. When the gradient change result corresponding to the reference key point reaches an angle threshold, the gradient change result corresponding to the reference key point meets the gradient change condition. For example, the angle threshold is set to 120 degrees in advance. When the gradient change result corresponding to the reference key point is 130 degrees, the gradient change result corresponding to the reference key point meets the gradient change condition.
2. A continuous angle threshold is set in advance. When the gradient change results corresponding to several adjacent reference key points exceed the continuous angle threshold, the gradient change results corresponding to the several reference key points meet the gradient change condition. For example, the continuous angle threshold is set as three gradient change results in advance, all of which are 60 degrees. However, a gradient change result corresponding to the reference key point a is 80 degrees, a gradient change result corresponding to the reference key point b is 120 degrees, and a gradient change result corresponding to the reference key point c is 110 degrees, all of which exceed the continuous angle threshold. Therefore, the reference key point a, the reference key point b, and the reference key point c meet the gradient change condition.
3. An angle change threshold is set in advance. When a corresponding angle change value between the gradient 1 change results corresponding to the two adjacent reference key points does not reach the angle change threshold value, the two adjacent reference key points are used as the reference key points that meet the gradient change condition. For example, the angle change threshold is set to 30 degrees in advance. If a gradient change result corresponding to a reference key point p is 60 degrees, and a gradient change result corresponding to a reference key point q is 75 degrees, the angle change threshold between the reference key point p and the reference key point q is 15 degrees, which does not reach 30 degrees, indicating that the reference key point p and the reference key point q meet the gradient change conditions.

The foregoing gradient change conditions are merely schematic examples, which are not limited in this embodiment of this application.

In some embodiments, in a case that the reference key point meets the gradient change condition, the reference key point is labeled as the target key point.

For example, a quantity of the target key points is less than or equal to a quantity of the reference key points.

Operation 250: Determine a target contour corresponding to the target object based on key point connection results among the plurality of target key points, contour edge flatness of the target contour being higher than that of the reference contour.

The contour edge flatness of the target contour is higher than that of the reference contour. The flatness may be measured by a quantity of jumps on a contour line. A jump on the contour line is a sudden change of a shape of the contour line, for example, a sudden sharp bending angle.

In some implementations, the key point connection result refers to a result obtained after the plurality of target key points are connected in a specified order.

For example, the contour corresponding to the key point connection result is used as the target contour corresponding to the target object.

In some embodiments, the key point connection result obtained by connecting the plurality of target key points is directly used as the target contour of the target object. Alternatively, after the key point connection result obtained by connecting the plurality of target key points is obtained, edge filtering is performed on the key point connection result to provide a filtering result as the target contour, which is not limited.

For example, the contour edge flatness refers to a quantity of burrs on the edge of the target contour and a burr distribution. When the contour edge flatness of the target contour is higher than that of the reference contour, it means that the quantity of burrs of the target contour is less than that of the edge of the reference contour, and the burr distribution of the target contour is sparser than that of the reference contour.

Based on the above, according to the object contour adjustment method provided in the embodiments of this application, in the process of performing contour recognition on the target object in the target image to obtain the reference contour, the reference contour includes a plurality of reference key points in a case that the reference contour is an irregular-shaped contour. during traversal of the plurality of reference key points, the angle between the contour edges obtained by connecting the adjacent reference key points in the reference contour is determined as the gradient change result corresponding to the reference key point. When a reference key point that meets a gradient change condition exists, the reference key point is determined as the target key point. The target contour corresponding to the target object is determined based on key point connection results among the plurality of target key points. In addition, contour edge flatness corresponding to the target contour is higher than that of the reference contour. In other words, the gradient change result corresponding to each of the reference key points in the reference contour is determined, so that the reference key points are screened based on the gradient change condition, and a key point connection result obtained by connecting selected target key points is determined as the target contour, thereby improving edge smoothness of an object contour, and further improving accuracy and aesthetics of contour adjustment.

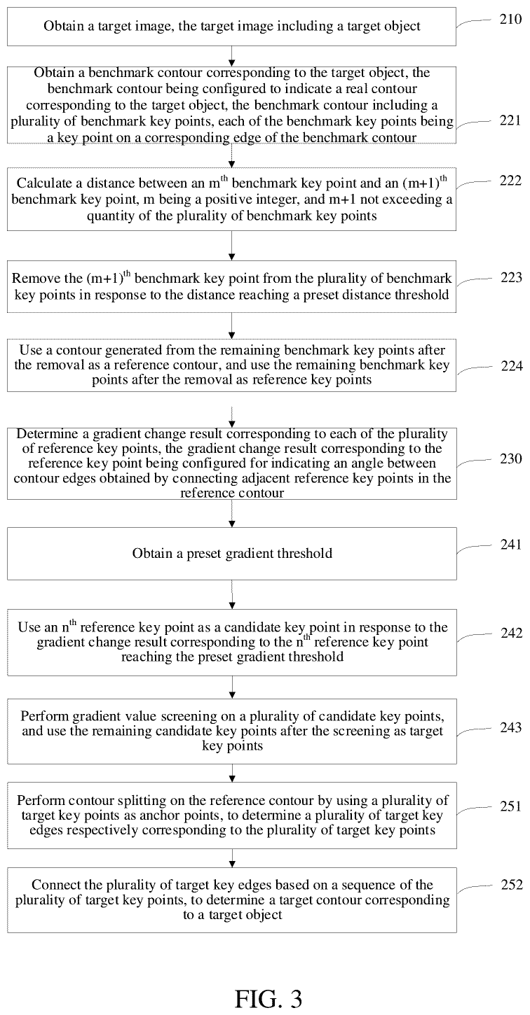

In some embodiments, the target key point is determined by the preset gradient threshold. For example, refer to FIG. 3. In other words, operation 220 includes operation 221 to operation 224. Operation 240 further includes operation 241 to operation 243. Operation 250 further includes operation 251 and operation 252. As shown in FIG. 3, the method includes the following operations.

Operation 210: Obtain a target image, the target image including a target object.

The target image includes the target object.

In some embodiments, the target image is a captured image generated by photographing a specified scene within a specified photographing angle range by using a specified photographing device. Alternatively, the target image refers to an image designed by the user. Alternatively, the target image is an image downloaded by the user from the authorized public website.

The specified photographing device includes at least one of devices such as a digital camera, a satellite camera, and a terminal camera.

In some embodiments, the target image includes at least one target object.

In some embodiments, when the target image includes a plurality of objects, all objects are used as the target objects. Alternatively, at least one target object is selected from the plurality of objects, which is not limited.

Operation 221: Obtain a benchmark contour corresponding to the target object, the benchmark contour being configured to indicate a real contour corresponding to the target object, the benchmark contour including a plurality of benchmark key points, each of the benchmark key points being a key point on a corresponding edge of the benchmark contour.

The benchmark contour is configured to indicate the real contour corresponding to the target object, the benchmark contour includes a plurality of benchmark key points, and each of the benchmark key points is a key point on a corresponding edge of the benchmark contour.

For example, the real contour of the target object is obtained first and used as the benchmark contour. The benchmark contour is a contour generated from an actual edge of the target object. The benchmark key point is the key point on the edge corresponding to the benchmark contour.

In this embodiment, the benchmark contour of the target object is obtained by constructing a canvas and filling the canvas with the target object.

In this embodiment, a target canvas is constructed first. A canvas size of the target canvas is adapted to an image size of the target image. For example, the image size of the target image is 60 cm×45 cm, and the canvas size of the target canvas is 70 cm×50 cm.

Each pixel point in the target canvas is labeled as 0.

In this embodiment, the target canvas is filled with the target object in the target image. On a filled target canvas, the pixel point corresponding to the target object is labeled as 1.

In some embodiments, a specified position on the target canvas is filled with the target object. For example, a center of the target canvas is filled. In other words, a pixel point corresponding to a central position of the target canvas is labeled as 1. Alternatively, the target canvas is correspondingly filled with the target object based on a corresponding position on the target image. In other words, a position of the target object on the target image corresponds to a position of the target object on the target canvas.

In this embodiment, morphological processing is performed on the filled target canvas, such as a closing operation. A closing operation of first dilation and then erosion with a kernel size of 15 is performed on the filled target canvas. The closing operation may cause a contour line of the target object to be smoother.

In this embodiment, a specified function is configured for performing contour retrieval on the target canvas on which the morphological processing is performed. A plurality of key points corresponding to an outermost contour of the target object are retrieved as a set of key points. A contour corresponding to the set of key points is the real contour of the target object, and the specified function is a function Find Contours.

Operation 222: Calculate a distance between an m^{th} benchmark key point and an (m+1)^{th} benchmark key point, m being a positive integer, and m+1 not exceeding a quantity of the plurality of benchmark key points.

m is a positive integer, m+1 does not exceed a quantity of the plurality of benchmark key points, and a value of m does not exceed the quantity of the plurality of benchmark key points.

In this embodiment, with any benchmark key point as a starting point, the plurality of benchmark key points are traversed in sequence, and a distance between any two adjacent benchmark key points is calculated. A Euclidean distance between any two adjacent benchmark key points is obtained through a Euclidean calculation formula, thereby determining the Euclidean distance corresponding to each of the plurality of key points.

Operation 223: Remove the (m+1)^{th} benchmark key point from the plurality of benchmark key points in response to the distance reaching a preset distance threshold.

In this embodiment, a preset distance threshold is set in advance. When the Euclidean distance between the m^{th} benchmark key point and the (m+1)^{th} benchmark key point reaches a distance threshold, a next benchmark key point adjacent to the benchmark key point is removed from the plurality of benchmark key points. For example, a Euclidean distance between a benchmark key point a and a benchmark key point b is calculated to obtain 5 pixel points. If the preset distance threshold is set to 3 pixel points in advance, the Euclidean distance between the benchmark key point a and the benchmark key point b is greater than the preset distance threshold. The benchmark key point b is removed from the plurality of benchmark key points, and the benchmark key point a is retained. In another implementable case, when the Euclidean distance between the m^{th} benchmark key point the (m+1)^{th} benchmark key point reaches the distance threshold, the mₜₕ benchmark key point is removed from the plurality of benchmark key points.

Operation 224: Use a contour generated from the remaining benchmark key points after the removal as a reference contour, and use the remaining benchmark key points after the removal as reference key points.

In this embodiment, the contour generated from the plurality of benchmark key points obtained after the removal is used as a reference contour of the target object, and the remaining benchmark key points after the removal are used as the reference key points.

Operation 230: Determine a gradient change result corresponding to each of the plurality of reference key points, the gradient change result corresponding to the reference key point being configured for indicating an angle between contour edges obtained by connecting adjacent reference key points in the reference contour.

In some embodiments, during traversal of the plurality of reference key points, a first adjacent key point and a second adjacent key point corresponding to an n^{th} reference key point are determined, n being a positive integer and not exceeding a quantity of the plurality of reference key points. A first contour edge between the n^{th} reference key point and the first adjacent key point is determined based on the reference contour. A second contour edge between the n^{th} reference key point and the second adjacent key point is determined based on the reference contour. The gradient change result corresponding to the n^{th} reference key point is determined based on a target angle among the first contour edge, the n^{th} reference key point, and the second contour edge, the target angle referring to an angle toward an inner side of the reference contour after the first contour edge and the second contour edge are connected by the n^{th} reference key point.

In this embodiment, with any reference key point as the starting point of traversal, the plurality of reference key points are traversed. During the traversal, two adjacent key points corresponding to each reference key point are determined. A description is provided by using the first adjacent key point and the second adjacent key point corresponding to the n^{th} reference key point as an example. After the first adjacent key point and the second adjacent key point corresponding to the n^{th} reference key point are determined, a connection line between the nth reference key point and the first adjacent key point is determined as the first contour edge based on an edge corresponding to the reference contour. In other words, the first contour edge refers to a connection line segment of the n^{th} reference key point and the first adjacent key point on the reference contour. Similarly, a connection line between the n^{th} reference key point and the second adjacent key point is obtained as the second contour edge based on the edge corresponding to the reference contour.

In this embodiment, after the first contour edge and the second contour edge corresponding to the n^{th} reference key point are determined, the gradient change result corresponding to the n^{th} reference key point is determined based on a target angle formed by the first contour edge, the n^{th} reference key point, and the second contour edge. The target angle refers to an angle formed by the first contour edge, the n^{th} reference key point, and the second contour edge toward an inner side of the target object. For example, when the reference contour of the target object is a closed irregular figure, the target angle refers to an angle toward an interior of the irregular figure, which may be referred to as an “inner angle”.

Operation 241: Obtain a preset gradient threshold.

In this embodiment, a preset gradient threshold is set in advance. For example, an angle of 90 degrees is set as the preset gradient threshold.

Operation 242: Use the n^{th} reference key point as a candidate key point in response to the gradient change result corresponding to the n^{th} reference key point reaching the preset gradient threshold.

In this embodiment, when the gradient change results corresponding to the plurality of reference key points are obtained, the reference key point that reaches the preset gradient threshold is used as a candidate key point, and the reference key point that does not reach the preset gradient threshold is not used as the candidate key point.

Operation 243: Perform gradient value screening on a plurality of candidate key points, and use the remaining candidate key points after the screening as the target key points.

For example, the gradient value screening refers to screening out at least two target key points from the plurality of candidate key points. A gradient value screening manner includes a non-maximum value suppression method.

The non-maximum suppression method means that a local maximum value is removed within a specified pixel point range, and the remaining values are used as a target value set.

In some embodiments, a target pixel point range is determined based on pixel point coordinates respectively corresponding to the plurality of candidate key points. Gradient change results respectively corresponding to at least two candidate key points within the target pixel point range are sorted, to obtain a gradient sorting result. At least one candidate key point is removed from the gradient sorting result, to obtain a key point removal result. The candidate key point in the key point removal result is used as the target key point.

In this embodiment, after the plurality of candidate key points are obtained, the pixel point coordinates corresponding to each candidate key point in the target canvas are determined to obtain the target pixel point range. For example, the pixel point coordinates are used as a center of a pixel point (2, 4), and a pixel point range within 20 pixel points is used as the target pixel point range.

In this embodiment, the candidate key points within the target pixel point range are sorted. A sorting index is the gradient change result corresponding to each candidate key point, so that the gradient sorting result corresponding to at least two candidate key points within the target pixel point range can be obtained. At least one gradient change result with a highest gradient change result and the corresponding candidate key point are removed from the gradient sorting result, and the remaining candidate key points after the gradient change result is removed from the target pixel point range are used as the target key points.

Operation 251: Perform contour splitting on the reference contour by using the plurality of target key points as anchor points, to determine a plurality of target key edges respectively corresponding to the plurality of target key points.

For example, the contour splitting refers to splitting the reference contour into a plurality of line segments by using the plurality of target key points as the anchor points, which are used as the target key edges corresponding to the target key points. The target key points correspond to two target key edges.

In some embodiments, the plurality of target key points are sorted based on a specified dimension, to obtain a key point sorting result. Adjacent target key points are connected based on the key point sorting result during traversal of the plurality of target key points, to obtain a key edge. A plurality of key edges are smoothed to obtain the plurality of target key edges.

In this embodiment, since each target key point has specified pixel point coordinates (X, Y) in the target canvas, sorting a plurality of target key points based on a specified dimension includes sorting the target key points based on numerical values of abscissas (X coordinates) thereof or sorting the target key points based on numerical values of ordinates (Y coordinates) thereof.

In some embodiments, sorting is performed only based on the numerical values of the abscissas. Alternatively, sorting is performed only based on the numerical values of the ordinates. Alternatively, sorting is performed based on the numerical values of the abscissas first. If at least two target key points with the same numerical value of the abscissa exist, sorting is performed based on the numerical values of the ordinates, which is not limited.

In this embodiment, the result obtained by sorting the plurality of target key points based on a specified dimension is used as the key point sorting result. The plurality of target key points are traversed based on the key point sorting result, and the adjacent target key points are connected to obtain the key edges corresponding to the target key points.

For example, after the key edges corresponding to the plurality of target key points are determined, a plurality of key edges are smoothed to obtain the plurality of target key edges. A quantity of target key edges is less than a quantity of key edges.

In some embodiments, a filtering window and a filter order are determined. Filtering and convolution are respectively performed on the plurality of key edges through a data filter based on the filtering window and the filter order, to obtain the plurality of target key edges.

In this embodiment, a specified signal filter is first determined. A filtering window and a filter order corresponding to the specified signal filter are set. Based on the set signal filter, the key edge corresponding to the target key point is inputted into the signal filter to perform filtering and convolution on the plurality of key edges, and filtering and convolution results corresponding to the plurality of key edges are outputted, thereby obtaining the plurality of target key edges. In this embodiment, a data filter savgol_filter is configured to smooth and denoise an inputted data stream.

The filtering window may be implemented as a preset range of window values. For example, a window range is (5, 8). Alternatively, a window value corresponding to the filtering window may be implemented as a preset window value. For example, the window value is 7.

The filter order may be implemented as a preset order range. For example, an order range is (2, 8). Alternatively, an order value may be implemented as a preset order value. For example, an order is 3.

Operation 252: Connect the plurality of target key edges based on a sequence of the plurality of target key points, to determine a target contour corresponding to a target object.

In this embodiment, after the plurality of target key edges are obtained from the plurality of key edges, the plurality of target key edges are connected based on a key point sorting result corresponding to the target key points corresponding to the target key edges, so that an edge line obtained through the connection is used as the target contour corresponding to the target object.

In this embodiment, burrs on the target contour obtained through the foregoing method are less than those on the reference contour. In other words, contour edge flatness of the target contour is higher than that of the reference contour.

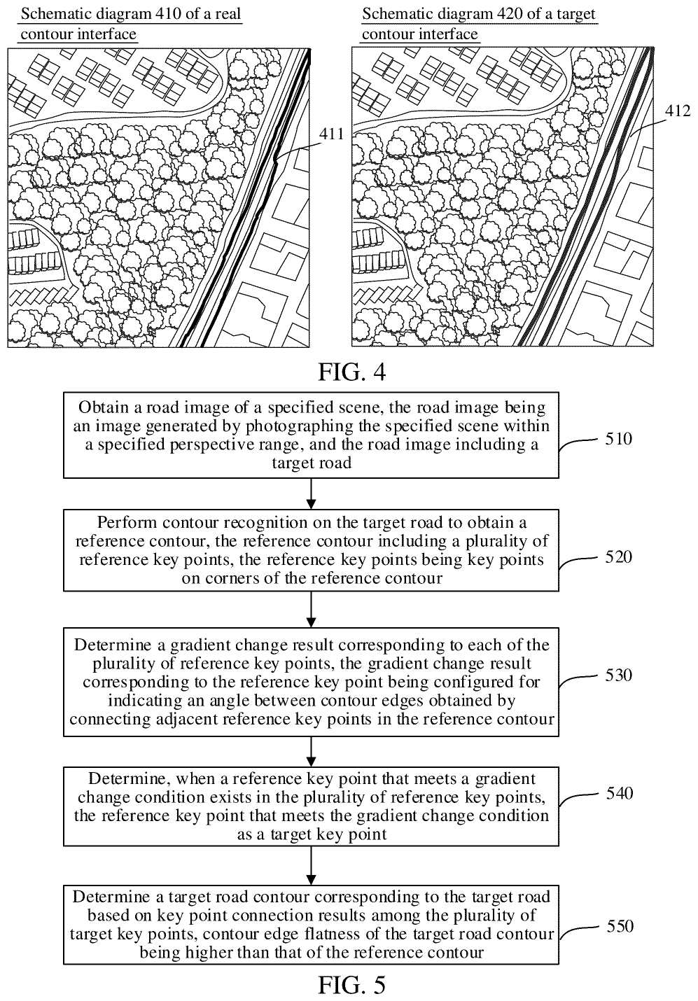

For example, FIG. 4 is a comparison diagram of a target contour and a real contour according to an exemplary embodiment of this application. As shown in FIG. 4, a schematic diagram 410 of a real contour interface and a schematic diagram 420 of a target contour interface are currently displayed. It may be learned from FIG. 4 that a target contour 411 corresponding to a target object retains an original contour shape based on a real contour 412 corresponding to the target object, so that flatness of a contour edge of the target contour 411 is higher than that of the real contour 412.

Based on the above, according to the object contour adjustment method provided in the embodiments of this application, in the process of performing contour recognition on the target object in the target image to obtain the reference contour, the reference contour includes a plurality of reference key points in a case that the reference contour is an irregular-shaped contour. during traversal of the plurality of reference key points, the angle between the contour edges obtained by connecting the adjacent reference key points in the reference contour is determined as the gradient change result corresponding to the reference key point. When a reference key point that meets a gradient change condition exists, the reference key point is determined as the target key point. The target contour corresponding to the target object is determined based on key point connection results among the plurality of target key points. In addition, contour edge flatness corresponding to the target contour is higher than that of the reference contour. In other words, the gradient change result corresponding to each of the reference key points in the reference contour is determined, so that the reference key points are screened based on the gradient change condition, and a key point connection result obtained by connecting selected target key points is determined as the target contour, thereby improving edge smoothness of an object contour, and further improving accuracy and aesthetics of contour adjustment.

In this embodiment, the gradient change result corresponding to the reference key point is determined by setting a preset gradient threshold. The reference key point corresponding to the gradient change result that reaches the preset gradient threshold is used as the candidate key point, so that the corners of the real contour of the target object can be retained, and accuracy of the contour adjustment is improved.

In this embodiment, the gradient change results corresponding to the candidate key points within the target pixel point range are sorted by determining the target pixel point range. Based on the gradient sorting results, the candidate key points are removed to determine final target key points, which can effectively reduce an amount of noise and improve the edge flatness of the contour adjustment.

In this embodiment, during traversal of the plurality of reference key points, the first contour edge and the second contour edge corresponding to the reference key point are determined, so that the angle between the first contour edge and the second contour edge is determined as the gradient change result, which can improve accuracy of the contour adjustment.

In this embodiment, after a set of key points that includes the plurality of key points is obtained, a distance between two adjacent key points is calculated. The distance between two adjacent key points is determined based on the preset distance threshold, so as to remove some key points and use the remaining key points as the reference key points, which can reduce the burrs of the target contour of the target object.

In this embodiment, the edge flatness of the contour can be improved by performing contour splitting on the reference contour by using the plurality of target key points as anchor points to obtain the target key edges.

In this embodiment, the key edges are obtained by sorting the target key points based on the specified dimension, and then the target key edges are obtained after smoothing, which can improve the contour edge flatness.

In some embodiments, for example, FIG. 5 is a flowchart of a road contour adjustment method according to an exemplary embodiment of this application. A description is provided by using an example in which the method is applied to a road contour recognition scene. As shown in FIG. 5, the method includes the following operations.

Operation 510: Obtain a road image of a specified scene, the road image being an image generated by photographing the specified scene within a specified perspective range, and the road image including a target road.

The road image is an image generated by photographing the specified scene within the specified perspective range, and the road image includes the target road. In this embodiment, in the road contour recognition scene, the target image is a road image, and the target object is a road.

In this embodiment, the road image refers to a captured image that includes the target road after a specified scene within a specified perspective range is photographed by using a specified photographing device.

The specified photographing device includes at least one of devices such as a digital camera, a satellite camera, and a terminal camera.

In some embodiments, the road image includes at least one target road.

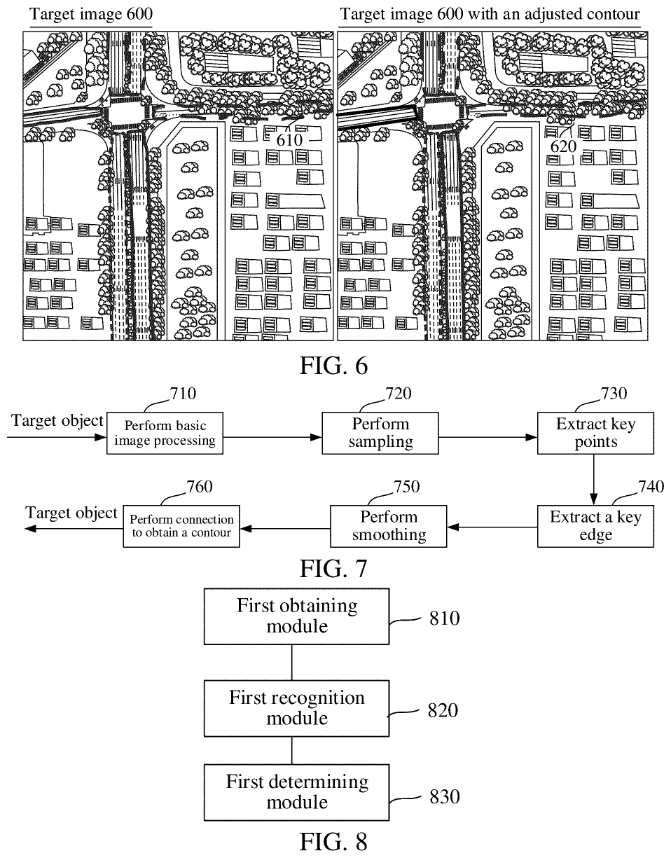

For example, FIG. 6 is a schematic comparison diagram of a target image according to an exemplary embodiment of this application and an image obtained by processing the target image by using a road contour adjustment method. As shown in FIG. 6, a target image 600 is currently displayed. The target image 600 includes a real contour 610 of the target road. It may be learned from FIG. 6 that the real contour of the target road is an irregular-shaped contour. A plurality of burrs exists on the real contour of the target road, and the contour has low edge flatness.

Operation 520: Perform contour recognition on the target road to obtain a reference contour, the reference contour including a plurality of reference key points, the reference key points being key points on corners of the reference contour.

The reference contour includes a plurality of reference key points, and the reference key points are key points on corners of the reference contour.

For example, after contour recognition is performed on the target road in the road image, the reference contour corresponding to the target road is determined. The reference contour includes a plurality of reference key points corresponding to the target road.

Operation 530: Determine a gradient change result corresponding to each of the plurality of reference key points, the gradient change result corresponding to the reference key point being configured for indicating an angle between contour edges obtained by connecting adjacent reference key points in the reference contour.

The gradient change results corresponding to the reference key points are configured for indicating an angle between the contour edges obtained by connecting adjacent reference key points in the reference contour.

For example, with any reference key point as the starting point of traversal, during traversal of the plurality of reference key points, an adjacent reference key point corresponding to each reference key point is determined first. Two line segments obtained by connecting the reference key point and the adjacent key point are used as the first contour edge and the second contour edge. An angle between the first contour edge and the second contour edge is calculated as a gradient change result corresponding to the reference key point. The angle between the first contour edge and the second contour edge is an angle towards an interior of the target road.

Operation 540: Determine, when a reference key point that meets a gradient change condition exists in the plurality of reference key points, the reference key point that meets the gradient change condition as a target key point.

For example, a preset gradient threshold is set in advance. When the gradient change result corresponding to the reference key point reaches the preset gradient threshold, the reference key point is used as a candidate key point.

For example, the target pixel point range is determined among the plurality of candidate key points. In the target pixel point range, non-maximum suppression is performed to screen the plurality of candidate key points, and the remaining candidate key points after screening are used as the target key points.

Operation 550: Determine a target road contour corresponding to the target road based on key point connection results among the plurality of target key points.

Contour edge flatness of the target road contour is higher than that of the reference contour.

For example, after the target key points corresponding to the target road are determined, contour splitting is performed on the reference contour based on the target key points. The key edge corresponding to the target key point is determined, and the key edge is smoothed through the data filter, and the target key edge is outputted.

For example, the target key edges are connected based on the target key point, to obtain the key point connection result as the target road contour corresponding to the target road.

For example, as shown in FIG. 6, the target road contour 620 corresponding to the target road is currently displayed. It may be learned from FIG. 6 that the target road contour of the target road obtained by the above method can improve the flatness of the contour edge while ensuring that a real contour shape exists.

Based on the above, according to the object contour adjustment method provided in the embodiments of this application, in the process of performing contour recognition on the target object in the target image to obtain the reference contour, the reference contour includes a plurality of reference key points in a case that the reference contour is an irregular-shaped contour. during traversal of the plurality of reference key points, the angle between the contour edges obtained by connecting the adjacent reference key points in the reference contour is determined as the gradient change result corresponding to the reference key point. When a reference key point that meets a gradient change condition exists, the reference key point is determined as the target key point. The target contour corresponding to the target object is determined based on key point connection results among the plurality of target key points. In addition, contour edge flatness corresponding to the target contour is higher than that of the reference contour. In other words, the gradient change result corresponding to each of the reference key points in the reference contour is determined, so that the reference key points are screened based on the gradient change condition, and a key point connection result obtained by connecting selected target key points is determined as the target contour, thereby improving edge smoothness of an object contour, and further improving accuracy and aesthetics of contour adjustment.

In some embodiments, for example, FIG. 7 is a schematic diagram of an object contour adjustment method according to an exemplary embodiment of this application. As shown in FIG. 7, the method includes the following operations.

Operation 710: Perform basic image processing.

After a target image is obtained, an initial adjustment is performed on a target object in the target image.

First, a target canvas adapted to an image size of the target image is constructed, and each pixel point in the target canvas is labeled as 0.

Second, the target canvas is filled with the target object in the target image, and a pixel point on the target canvas corresponding to the target object after filling is labeled as 1.

Next, morphological processing of first erosion and then dilation with a kernel size of 15 is performed on the target canvas.

Finally, key points corresponding to a real contour of the target object are retrieved from the target canvas through a specified function.

Operation 720: Perform sampling.

During sampling of the key points, with any key point as a starting point of traversal, a Euclidean distance between two adjacent key points is calculated during traversal of a plurality of key points. When the Euclidean distance between two adjacent key points reaches a preset distance threshold, a latter one of the two adjacent key points is removed, a former one of the key points is retained as a reference key point, and finally a reference contour corresponding to the target object is obtained. The reference contour includes a plurality of reference key points.

Operation 730: Extract the key points.

During extraction of the key points, with any reference key point as the starting point of traversal, during traversal of the plurality of reference key points, an adjacent reference key point corresponding to each reference key point is determined. A first contour edge and a second contour edge corresponding to the reference key point are determined based on a connection line between the reference key point and the adjacent reference key point. An angle between the first contour edge and the second contour edge is calculated as a gradient change result corresponding to the reference key point.

A preset gradient threshold is set in advance. When the gradient change result corresponding to the reference key point reaches a preset gradient threshold, the reference key point is used as a candidate key point.

After a plurality of candidate key points are determined, a target pixel point range is obtained. Non-maximum suppression is performed on at least two candidate key points within the target pixel point range, and the remaining candidate key points are used as target key points.

Operation 740: Extract a key edge.

After the target key points are obtained, sorting is performed based on a specified dimension (based on X-axis coordinate values or Y-axis coordinate values) to obtain a key point sorting result. A plurality of target key points are traversed based on the key point sorting result, and two adjacent target key points are formed as a line segment, so as to obtain the key edge corresponding to the target key points.

Operation 750: Perform smoothing.

By setting a filtering window to 7 and a filter order to 3, the key edge is inputted into a specified data filter to perform data smoothing, and a target key edge corresponding to the target key point is outputted.

Operation 760: Perform connection to obtain a contour.

The target key edges are connected based on the key point sorting result of the target key points, and finally a target contour of the target object is generated.

Based on the above, according to the object contour adjustment method provided in the embodiments of this application, in the process of performing contour recognition on the target object in the target image to obtain the reference contour, the reference contour includes a plurality of reference key points in a case that the reference contour is an irregular-shaped contour. During traversal of the plurality of reference key points, the angle between the contour edges obtained by connecting the adjacent reference key points in the reference contour is determined as the gradient change result corresponding to the reference key point. When a reference key point that meets a gradient change condition exists, the reference key point is determined as the target key point. The target contour corresponding to the target object is determined based on key point connection results among the plurality of target key points. In addition, contour edge flatness corresponding to the target contour is higher than that of the reference contour. In other words, the gradient change result corresponding to each of the reference key points in the reference contour is determined, so that the reference key points are screened based on the gradient change condition, and a key point connection result obtained by connecting selected target key points is determined as the target contour, thereby improving edge smoothness of an object contour, and further improving accuracy and aesthetics of contour adjustment.

FIG. 8 is a structure diagram of an object contour adjustment apparatus according to an exemplary embodiment of this application. As shown in FIG. 8, the apparatus includes:
a first obtaining module 810, configured to obtain a target image, the target image including a target object;

a first recognition module 820, configured to perform contour recognition on the target object to obtain a reference contour, the reference contour including a plurality of reference key points, the reference key points being key points on corners of the reference contour; and
a first determining module 830, configured to determine a gradient change result corresponding to each of the plurality of reference key points, the gradient change result corresponding to the reference key point being configured for indicating an angle between contour edges obtained by connecting adjacent reference key points in the reference contour.

The first determining module 830 is further configured to determine, when a reference key point that meets a gradient change condition exists in the plurality of reference key points, the reference key point that meets the gradient change condition as a target key point.

The first determining module 830 is further configured to determine a target contour corresponding to the target object based on key point connection results among the plurality of target key points, contour edge flatness of the target contour being higher than that of the reference contour.

In some embodiments, the first determining module 830 is further configured to: determine a first adjacent key point and a second adjacent key point corresponding to an nth reference key point, n being a positive integer and not exceeding a quantity of the plurality of reference key points; determine a first contour edge between the n^{th} reference key point and the first adjacent key point based on the reference contour; determine a second contour edge between the n^{th} reference key point and the second adjacent key point based on the reference contour; and determine the gradient change result corresponding to the n^{th} reference key point based on a target angle among the first contour edge, the n^{th} reference key point, and the second contour edge, the target angle referring to an angle toward an inner side of the reference contour after the first contour edge and the second contour edge are connected by the n^{th} reference key point.

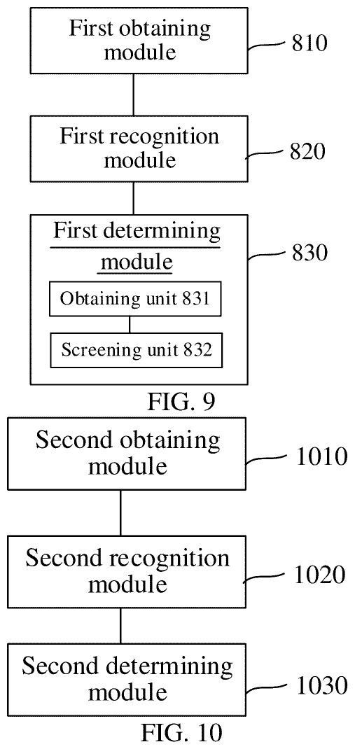

In some embodiments, as shown in FIG. 9, the first determining module 830 includes:
an obtaining unit 831, configured to obtain a preset gradient threshold;
the obtaining unit 831 being further configured to use the n^{th} reference key point as a candidate key point in response to the gradient change result corresponding to the nth reference key point reaching the preset gradient threshold, i being a positive integer; and
a screening unit 832, configured to perform gradient value screening on a plurality of candidate key points, and use the remaining candidate key points after the screening as the target key points.

In some embodiments, the screening unit 832 is further configured to: determine a target pixel point range based on pixel point coordinates respectively corresponding to the plurality of candidate key points; sort gradient change results respectively corresponding to at least two candidate key points within the target pixel point range, to obtain a gradient sorting result; remove at least one candidate key point from the gradient sorting result, to obtain a key point removal result; and use the candidate key point in the key point removal result as the target key point.

In some embodiments, the first recognition module 820 is further configured to: obtain a benchmark contour corresponding to the target object, the benchmark contour being configured to indicate a real contour corresponding to the target object, the benchmark contour including a plurality of benchmark key points, the benchmark key points being key points on corresponding edges of the benchmark contour; calculate a distance between an m^{th} benchmark key point and an (m+1)^{th} benchmark key point, m being a positive integer, and m+1 not exceeding a quantity of the plurality of benchmark key points; remove the (m+1)^{th} benchmark key point from the plurality of benchmark key points in response to the distance reaching a preset distance threshold; and use a contour generated from the remaining benchmark key points after the removal as the reference contour, and use the remaining benchmark key points after the removal as the reference key points.

In some embodiments, the first determining module 830 is further configured to: perform contour splitting on the reference contour by using the plurality of target key points as anchor points, to determine a plurality of target key edges respectively corresponding to the plurality of target key points; and connect the plurality of target key edges based on a sequence of the plurality of target key points, to determine the target contour corresponding to the target object.

In some embodiments, the first determining module 830 is further configured to: sort the plurality of target key points based on a specified dimension, to obtain a key point sorting result; connect adjacent target key points based on the key point sorting result during traversal of the plurality of target key points, to obtain a key edge; and smooth a plurality of key edges, to obtain the plurality of target key edges.

In some embodiments, the first determining module 830 is further configured to: determine a filtering window and a filter order; and respectively perform filtering and convolution on the plurality of target key edges through a data filter based on the filtering window and the filter order, to obtain the plurality of target key edges.

FIG. 10 is a structure diagram of a road contour adjustment apparatus according to an exemplary embodiment of this application. As shown in FIG. 10, the apparatus includes:
a second obtaining module 1010, configured to obtain a road image of a specified scene, the road image being an image generated by photographing the specified scene within a specified perspective range, and the road image including a target road;
a second recognition module 1020, configured to perform contour recognition on the target road to obtain a reference contour, the reference contour including a plurality of reference key points, the reference key points being key points on corners of the reference contour; and
a second determining module 1030, configured to determine a gradient change result corresponding to each of the plurality of reference key points, the gradient change result corresponding to the reference key point being configured for indicating an angle between contour edges obtained by connecting adjacent reference key points in the reference contour.

The second determining module 1030 is further configured to: determine, when a reference key point that meets a gradient change condition exists in the plurality of reference key points, the reference key point that meets the gradient change condition as a target key point; and determine a target road contour corresponding to the target road based on key point connection results among the plurality of target key points, contour edge flatness of the target road contour being higher than that of the reference contour.

Based on the above, according to the object contour adjustment apparatus provided in the embodiments of this application, in the process of performing contour recognition on the target object in the target image to obtain the reference contour, the reference contour includes a plurality of reference key points in a case that the reference contour is an irregular-shaped contour. during traversal of the plurality of reference key points, the angle between the contour edges obtained by connecting the adjacent reference key points in the reference contour is determined as the gradient change result corresponding to the reference key point. When a reference key point that meets a gradient change condition exists, the reference key point is determined as the target key point. The target contour corresponding to the target object is determined based on key point connection results among the plurality of target key points. In addition, contour edge flatness corresponding to the target contour is higher than that of the reference contour. In other words, the gradient change result corresponding to each of the reference key points in the reference contour is determined, so that the reference key points are screened based on the gradient change condition, and a key point connection result obtained by connecting selected target key points is determined as the target contour, thereby improving edge smoothness of an object contour, and further improving accuracy and aesthetics of contour adjustment.

For the object contour adjustment apparatus and the road contour adjustment apparatus provided in the above embodiments, only division of the functional modules is described by using examples. In practical application, the functions are completed by different functional modules as required. In other words, an internal structure of the device is divided into different functional modules to complete all or a part of the functions described above. In addition, the object contour adjustment apparatus provided in the foregoing embodiments and the method embodiment of the object contour adjustment method belong to the same concept. The road contour adjustment apparatus provided in the foregoing embodiments and the method embodiment of the road contour adjustment method belong to the same concept. For details of a specific implementation process, reference may be made to the method embodiments. Details are not described herein again.

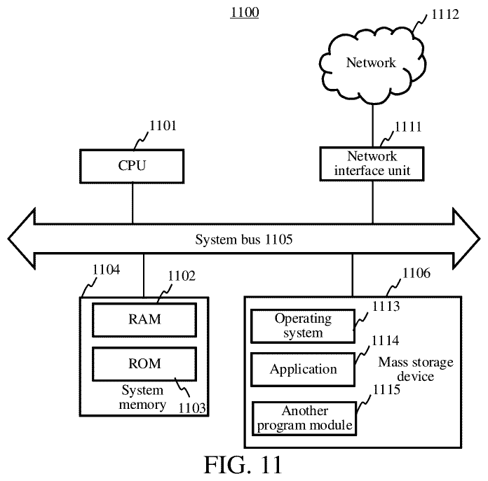

FIG. 11 is a schematic structural diagram of a server according to an exemplary embodiment of this application. Specifically,
a server 1100 includes a central processing unit (CPU) 1101, a system memory 1104 including a random access memory (RAM) 1102 and a read-only memory (ROM) 1103, and a system bus 1105 connecting the system memory 1104 to the CPU 1101. The server 1100 further includes a mass storage device 1106 configured to store an operating system 1113, an application 1114, and another program module 1115.

The mass storage device 1106 is connected to the CPU 1101 by using a mass storage controller (not shown) connected to the system bus 1105. The mass storage device 1106 and a computer-readable medium associated with the mass storage device provide non-volatile storage for the server 1100. In other words, the mass storage device 1106 may include a computer-readable medium (not shown) such as a hard disk or a compact disc ROM (CD-ROM) drive.

Generally, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in art can know that the computer storage medium is not limited to the foregoing several types. The system memory 1104 and the mass storage device 1106 may be collectively referred to as a memory.

According to various embodiments of this application, the server 1100 may be further connected to a remote computer on a network for running through a network such as the Internet. In other words, the server 1100 may be connected to a network 1112 through a network interface unit 1111 connected to the system bus 1105, or may be connected to other types of networks or remote computer systems (not shown) through the network interface unit 1111.

The foregoing memory further includes one or more programs, the one or more programs being stored in the memory and configured to be executed by the CPU.

An embodiment of this application further provides a computer device, including a processor and a memory, the memory having a computer-readable instruction stored therein, the computer-readable instruction being loaded and executed by the processor to implement the object contour adjustment method or the road contour adjustment method provided in the foregoing method embodiments.

Embodiments of this application provide a computer-readable storage medium, having a computer-readable instruction stored therein, the computer-readable instruction being loaded and executed by a processor to implement the object contour adjustment method or the road contour adjustment method provided in the foregoing method embodiments.

An embodiment of this application further provides a computer program product or a computer program, the computer program product or the computer program including a computer-readable instruction, the computer-readable instruction being stored in a computer-readable storage medium. A processor of the computer device reads the computer-readable instruction from the computer-readable storage medium. The processor executes the computer-readable instruction, causing the computer device to perform the object contour adjustment method or the road contour adjustment method according to any one of the foregoing embodiments.

In some embodiments, the computer-readable storage medium may include a read-only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this application are merely for description purpose but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, some transformations and improvements may be made without departing from the idea of this application. These transformations and improvements belong to the protection scope of this application. Therefore, the protection scope of the patent of this application is subject to the appended claims.

What is claimed is:

1. An object contour adjustment method, performed by a computer device, the method comprising:
obtaining a target image, the target image comprising a target object;
obtaining a reference contour by performing contour recognition on the target object, the reference contour comprising a plurality of reference key points, the plurality of reference key points being key points on corners of the reference contour;
determining a gradient change result corresponding to each of the plurality of reference key points, the gradient change result corresponding to the reference key point being configured to indicate an angle between contour edges, the contour edges being obtained by connecting adjacent reference key points in the reference contour;
determining the reference key points in the plurality of reference key points as a plurality of target key points when the reference key points meet a gradient change condition; and
determining a target contour corresponding to the target object based on a plurality of key point connection results of the plurality of target key points, a contour edge flatness of the target contour being higher than a contour edge flatness of the reference contour.

2. The method according to claim 1, wherein the reference contour is an irregular-shaped contour.

3. The method according to claim 1, wherein determining a gradient change result corresponding to each of the plurality of reference key points comprises:
determining a first adjacent key point and a second adjacent key point corresponding to an n^{th} reference key point, n being a positive integer and not exceeding a quantity of the plurality of reference key points;
determining a first contour edge between the n^{th} reference key point and the first adjacent key point based on the reference contour;
determining a second contour edge between the n^{th} reference key point and the second adjacent key point based on the reference contour; and
determining the gradient change result corresponding to the n^{th} reference key point based on a target angle between the first contour edge, the n^{th} reference key point, and the second contour edge, the target angle being an angle toward an inner side of the reference contour after the first contour edge connects to the second contour edge through the n^{th} reference key point.

4. The method according to claim 1, wherein determining the reference key points in the plurality of reference key points as a plurality of target key points when the reference key points meet a gradient change condition comprises:
obtaining a preset gradient threshold;
using an n^{th} reference key point as a candidate key point in response to the gradient change result corresponding to an n^{th} reference key point reaching the preset gradient threshold; and
performing a gradient value screening on a plurality of candidate key points and determining the remaining candidate key points after the gradient value screening as the plurality of target key points.

5. The method according to claim 4, wherein performing a gradient value screening on a plurality of candidate key points and determining the remaining candidate key points after the gradient value screening as the plurality of target key points comprises:
determining a target pixel point range based on pixel point coordinates respectively corresponding to the plurality of candidate key points;
obtaining a gradient sorting result by sorting gradient change results corresponding to at least two candidate key points within the target pixel point range;
obtaining a key point removal result by removing at least one candidate key point from the gradient sorting result; and
using the candidate key point in the key point removal result as the target key point.

6. The method according to claim 1, wherein obtaining a reference contour by performing contour recognition on the target object comprises:
obtaining a benchmark contour corresponding to the target object, the benchmark contour being configured to indicate a real contour corresponding to the target object, the benchmark contour comprising a plurality of benchmark key points, the plurality of benchmark key points being key points on corresponding edges of the benchmark contour;
calculating a distance between an m^{th} benchmark key point and an (m+1)^{th} benchmark key point, m being a positive integer, and m+1 not exceeding a quantity of the plurality of benchmark key points;
removing the (m+1)^{th} benchmark key point from the plurality of benchmark key points in response to the distance reaching a preset distance threshold; and
using a contour generated from the remaining benchmark key points after the removal as the reference contour, and using the remaining benchmark key points after the removal as the reference key points.

7. The method according to claim 1, wherein determining a target contour corresponding to the target object based on a plurality of key point connection results of the plurality of target key points comprises:
determining a plurality of target key edges corresponding to the plurality of target key points by using the plurality of target key points as anchor points and performing contour splitting on the reference contour; and
determining the target contour corresponding to the target object by connecting the plurality of target key edges based on a sequence of the plurality of target key points.

8. The method according to claim 7, wherein determining a plurality of target key edges corresponding to the plurality of target key points by using the plurality of target key points as anchor points and performing contour splitting on the reference contour comprises:
obtaining a key point sorting result by sorting the plurality of target key points based on a specified dimension;
obtaining a key edge by connecting adjacent target key points based on the key point sorting result during traversal of the plurality of target key points; and
obtaining the plurality of target key edges by smoothing a plurality of key edges.

9. The method according to claim 8, wherein obtaining the plurality of target key edges by smoothing a plurality of key edges comprises:
determining a filtering window and a filter order; and
obtaining the plurality of target key edges by performing filtering and convolution on the plurality of target key edges through a data filter based on the filtering window and the filter order.

10. The method according to claim 1, wherein a target image is a road image of a specified scene, the road image being an image generated by photographing the specified scene within a specified perspective range, and the road image comprising the target object, the target object being a target road.

11. An object contour adjustment apparatus, comprising a memory for storing instructions and a processor for executing the instructions, wherein the processor is configured to:
obtain a target image, the target image comprising a target object;
obtain a reference contour by performing contour recognition on the target object, the reference contour comprising a plurality of reference key points, the reference key points being key points on corners of the reference contour; and
determine a gradient change result corresponding to each of the plurality of reference key points, the gradient change result corresponding to the reference key point being configured to indicate an angle between contour edges, the contour edges being obtained by connecting adjacent reference key points in the reference contour;
determine the reference key points in the plurality of reference key points as a plurality of target key points when the reference key points meet a gradient change condition; and
determine a target contour corresponding to the target object based on a plurality of key point connection results of the plurality of target key points, contour edge flatness of the target contour being higher than a contour edge flatness of the reference contour.

12. The object contour adjustment apparatus of claim 11, comprising a memory for storing instructions and a processor for executing the instructions, wherein the reference contour is an irregular-shaped contour.

13. The object contour adjustment apparatus of claim 11, comprising a memory for storing instructions and a processor for executing the instructions, wherein the processor, being configured to determine a gradient change result corresponding to each of the plurality of reference key points, is further configured to:
determine a first adjacent key point and a second adjacent key point corresponding to an nth reference key point, n being a positive integer and not exceeding a quantity of the plurality of reference key points;
determine a first contour edge between the n^{th} reference key point and the first adjacent key point based on the reference contour;
determine a second contour edge between the n^{th} reference key point and the second adjacent key point based on the reference contour; and
determine the gradient change result corresponding to the n^{th} reference key point based on a target angle between the first contour edge, the n^{th} reference key point, and the second contour edge, the target angle being an angle toward an inner side of the reference contour after the first contour edge connects to the second contour edge through the n^{th} reference key point.

14. The object contour adjustment apparatus of claim 11, comprising a memory for storing instructions and a processor for executing the instructions, wherein the processor, being configured to determine the reference key points in the plurality of reference key points as a plurality of target key points when the reference key points meet a gradient change condition, is further configured to:
obtain a preset gradient threshold;
use an n^{th} reference key point as a candidate key point in response to the gradient change result corresponding to an n^{th} reference key point reaching the preset gradient threshold; and
perform a gradient value screening on a plurality of candidate key points and determine the remaining candidate key points after the gradient value screening as the plurality of target key points.

15. The object contour adjustment apparatus of claim 14, comprising a memory for storing instructions and a processor for executing the instructions, wherein the processor, being configured to perform a gradient value screening on a plurality of candidate key points and determine the remaining candidate key points after the gradient value screening as the plurality of target key points, is further configured to:
determine a target pixel point range based on pixel point coordinates respectively corresponding to the plurality of candidate key points;
obtain a gradient sorting result by sorting gradient change results corresponding to at least two candidate key points within the target pixel point range;
obtain a key point removal result by removing at least one candidate key point from the gradient sorting result; and
use the candidate key point in the key point removal result as the target key point.

16. The object contour adjustment apparatus of claim 11, comprising a memory for storing instructions and a processor for executing the instructions, wherein the processor, being configured to obtain a reference contour by performing contour recognition on the target object, is further configured to:
obtain a benchmark contour corresponding to the target object, the benchmark contour being configured to indicate a real contour corresponding to the target object, the benchmark contour comprising a plurality of benchmark key points, the plurality of benchmark key points being key points on corresponding edges of the benchmark contour;
calculate a distance between an m^{th} benchmark key point and an (m+1)^{th} benchmark key point, m being a positive integer, and m+1 not exceeding a quantity of the plurality of benchmark key points;
remove the (m+1)^{th} benchmark key point from the plurality of benchmark key points in response to the distance reaching a preset distance threshold; and
use a contour generated from the remaining benchmark key points after the removal as the reference contour, and use the remaining benchmark key points after the removal as the reference key points.

17. The object contour adjustment apparatus of claim 11, comprising a memory for storing instructions and a processor for executing the instructions, wherein the processor, being configured to determine a target contour corresponding to the target object based on a plurality of key point connection results of the plurality of target key points, is further configured to:
determine a plurality of target key edges corresponding to the plurality of target key points by using the plurality of target key points as anchor points and performing contour splitting on the reference contour; and
determine the target contour corresponding to the target object by connecting the plurality of target key edges based on a sequence of the plurality of target key points.

18. The object contour adjustment apparatus of claim 11, comprising a memory for storing instructions and a processor for executing the instructions, wherein a target image is a road image of a specified scene, the road image being an image generated by photographing the specified scene within a specified perspective range, and the road image comprising a target road.

19. A non-transitory computer readable medium storing a plurality of instructions, wherein the plurality of instructions, when executed by a processor, configure the processor to:
obtain a target image, the target image comprising a target object;
obtain a reference contour by performing contour recognition on the target object, the reference contour comprising a plurality of reference key points, the reference key points being key points on corners of the reference contour; and
determine a gradient change result corresponding to each of the plurality of reference key points, the gradient change result corresponding to the reference key point being configured to indicate an angle between contour edges, the contour edges being obtained by connecting adjacent reference key points in the reference contour;
determine the reference key points in the plurality of reference key points as a plurality of target key points when the reference key points meet a gradient change condition; and
determine a target contour corresponding to the target object based on a plurality of key point connection results of the plurality of target key points, contour edge flatness of the target contour being higher than a contour edge flatness of the reference contour.

20. The non-transitory computer readable medium according to claim 19, wherein a target image is a road image of a specified scene, the road image being an image generated by photographing the specified scene within a specified perspective range, and the road image comprising a target road.
